(19) United States
(12) Patent Application Publication
(10) Pub. No.: US 2020/0182155 A1
(43) Pub. Date: Jun. 11, 2020

(54) CASING WITH INTEGRAL CAVITY

(71) Applicant: UNITED TECHNOLOGIES CORPORATION, Farmington, CT (US)

(72) Inventors: Lawrence Binek, Glastonbury, CT (US); Evan Butcher, Suffield, CT (US); Jesse R. Boyer, Middletown, CT (US); Om P. Sharma, South Windsor, CT (US); Bryan G. Dods, Greer, SC (US); Vijay Narayan Jagdale, South Windsor, CT (US)

(21) Appl. No.: 16/213,047

(22) Filed: Dec. 7, 2018

(51) Int. Cl. F02C 7/26; F02C 7/22; B33Y 80/00; F23R 3/28

(52) U.S. Cl. CPC F02C 7/26; F02C 7/22; B33Y 10/00; F23R 3/28; B33Y 80/00

(57) ABSTRACT

A propulsion system according to an example of the present disclosure, includes a core engine and an outer casing surrounding the core engine. The outer casing includes an integral injector assembly. The injector assembly includes a wall that defines a cavity, the wall being integral with the outer casing. A method of operating a propulsion system and method of making a component of a propulsion system are also disclosed.

### BACKGROUND

Attritable or expendable propulsion systems are designed for single-use or only a few uses, as compared to typical flight applications (e.g., commercial aircraft) that are used repeatedly over hundreds or thousands of cycles. For example, the propulsion systems may be used to power small, unmanned aircraft. Still, the propulsion systems must be reliable and occasionally must exhibit a minimal degree of maintainability.

The attritable or expendable propulsion systems include a starter which utilizes an oxygen-containing fluid to provide a spark. The starter can include multiple separate components and associated fittings, such as a pressure bottle for holding the oxygen-containing fluid.

### SUMMARY

A propulsion system according to an example of the present disclosure, includes a core engine and an outer casing surrounding the core engine. The outer casing includes an integral injector assembly. The injector assembly includes a wall that defines a cavity, the wall being integral with the outer casing.

In a further embodiment according to any of the foregoing embodiments, the wall includes an inner wall portion and an outer wall portion with respect to a central engine axis. The inner wall portion corresponds to the engine casing.

In a further embodiment according to any of the foregoing embodiments, wall includes first and second curved side wall portions that join the inner wall portion and outer wall portion to one another.

In a further embodiment according to any of the foregoing embodiments, the cavity is elongated in a direction that is parallel to a central engine axis.

In a further embodiment according to any of the foregoing embodiments, the cavity is teardrop-shaped.

In a further embodiment according to any of the foregoing embodiments, at least a portion of the wall of the cavity borders a core flowpath of the core engine.

In a further embodiment according to any of the foregoing embodiments, the injector is in fluid communication with a starter.

In a further embodiment according to any of the foregoing embodiments, the injector is in fluid communication with the core engine.

In a further embodiment according to any of the foregoing embodiments, the injector is in fluid communication with a diffuser ring adjacent a combustor in the core engine.

In a further embodiment according to any of the foregoing embodiments, the injector is in fluid communication with the diffuser ring via a manifold.

A method of operating a propulsion system according to an example of the present disclosure includes starting a propulsion system by providing pressurized gas from a cavity to a starter. The starter is configured to create a pyrotechnic spark which enables start-up rotation of a core engine. The cavity is defined by a wall, the wall being integral with an outer casing of the propulsion system.

In a further embodiment according to any of the foregoing embodiments, the method of operating a propulsion system includes providing the pressurized gas from the cavity to the core engine.

In a further embodiment according to any of the foregoing embodiments, the method of operating a propulsion system includes charging the cavity with the pressurized gas prior to the starting step.

In a further embodiment according to any of the foregoing embodiments, the cavity is charged to a pressure of between about 10 and 500 psi.

In a further embodiment according to any of the foregoing embodiments, the cavity is depleted of pressurized gas by the starting step, and the cavity subsequently serves as an air gap.

A method of making a component of a propulsion system according to an example of the present disclosure includes depositing material using an additive manufacturing technique to form a component with an injector assembly. The injector assembly includes a cavity defined by a wall, the wall being integral with the component, and an injector in fluid communication with the cavity.

In a further embodiment according to any of the foregoing embodiments, the component is an outer casing of a propulsion system.

In a further embodiment according to any of the foregoing embodiments, the cavity has a long axis, and the long axis is generally parallel to a build direction in which the material is deposited.

In a further embodiment according to any of the foregoing embodiments, the cavity is oval-shaped.

In a further embodiment according to any of the foregoing embodiments, the cavity is teardrop shaped.

### BRIEF DESCRIPTION OF THE DRAWINGS

FIG. 1 schematically shows an attritable/expendable propulsion system.

FIG. 2A schematically shows an outer casing with integral injector assembly for the attritable/expendable propulsion system of FIG. 1.

FIG. 2B schematically shows an alternate outer casing with integral injector assembly for the attritable/expendable propulsion system of FIG. 1.

FIG. 3 schematically shows the injector assembly in fluid communication with the attritable/expendable propulsion system of FIG. 1.

FIG. 4 schematically shows an additive manufacturing tool.

### DETAILED DESCRIPTION

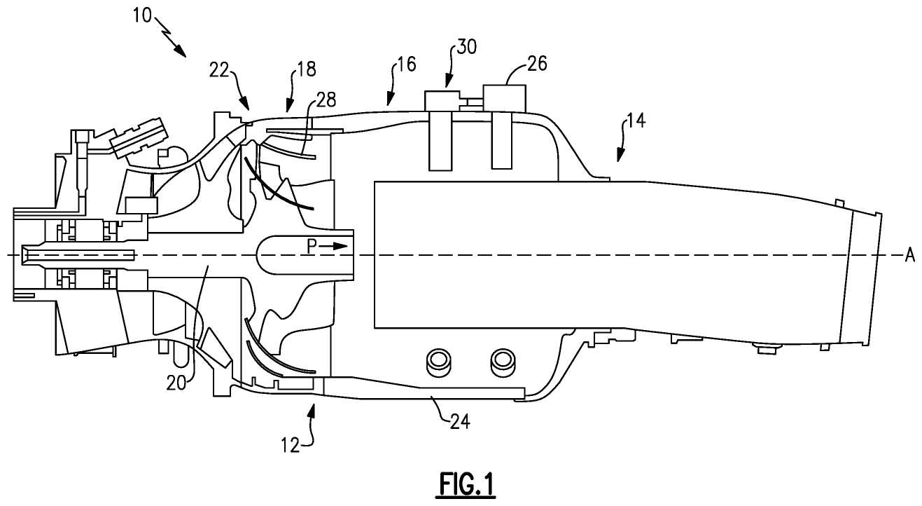

FIG. 1 schematically shows an example attritable/expendable propulsion system 10. The propulsion system 10 can be used to power an attritable/expendable aircraft, such as a small unmanned aircraft. The propulsion system 10 is designed for single-use or limited-use, but meets the reliability and maintainability requirements for the particular application. As an example, an attritable/expendable propulsion system may have a design life of only a few hours, after which the mission has ended and the propulsion system is rendered inoperable and cannot be recovered/refurbished.

The propulsion system 10 includes a core engine 12, which includes a compressor 14, a combustor 16, and a turbine 18 arranged along a shaft 20, which is arranged along central engine axis A. In general, air is drawn into a core engine passage P and into compressor 14 for compression and communication into the combustor 16 and then expansion through the turbine 18. Air exists the turbine via turbine nozzle 22. An outer casing 24 surrounds the core engine 12.

The propulsion system 10 may include various accessories related to operation. As an example, the propulsion system 10 includes a starter 26 that is used to start up the propulsion system 10. In a particular example, the starter 26 starts the compressor 14 and/or turbine 18 by providing a pyrotechnic spark that ignites fuel, which creates exhaust gas that moves vanes 28 in the turbine and begins the turbine 18 rotation. Since the turbine 18 and compressor 14 are arranged on a common shaft 20, rotation of the turbine 18 facilitates start-up rotation of the compressor 14.

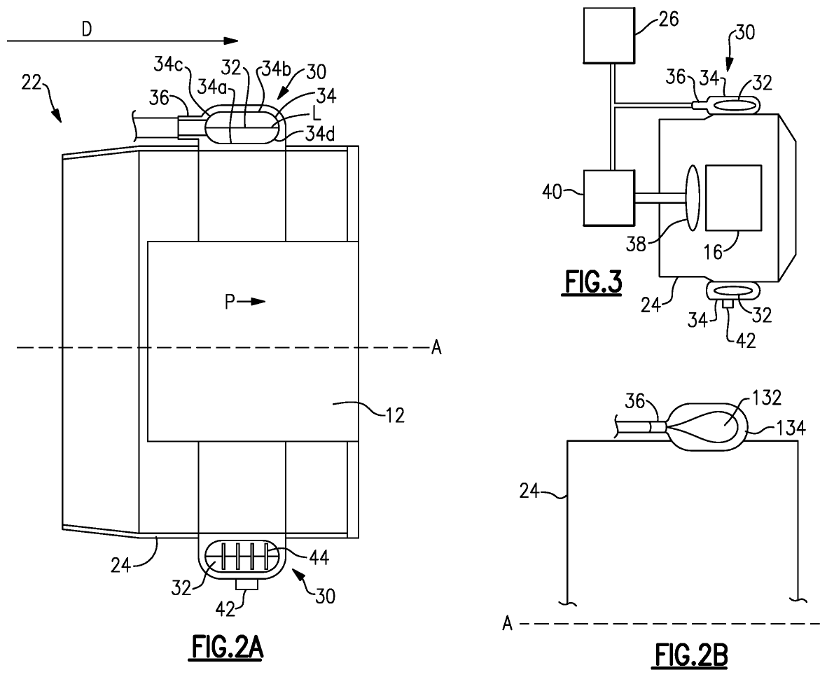

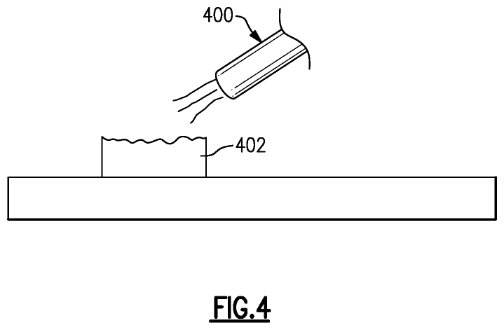

FIGS. 2 and 3 show selected portions of an injector assembly 30 for the starter 26. The injector assembly 30 also serves as an air gap, as will be discussed in more detail below. The injector assembly 30 provides air to the starter 26 which feeds the pyrotechnic spark.

In the example of FIG. 2A, the injector assembly 30 is part of, or integral with, the outer casing 24 of the propulsion system 10 which surrounds the core engine 12. However, it should be understood that the injector assembly 30 can be located in other casing-type structures in the propulsion system 10, such as a liner of the combustor 16.

The injector assembly 30 includes a cavity 32. The cavity 32 is defined by a wall 34. The wall 34 is integral with or unitary with the outer casing 24. The cavity 32 is annular and extends around the outer casing 24.

In the example of FIG. 2A, the wall 34 comprises an inner wall portion 34a and an outer wall portion 34b with respect to the engine axis A. In this example, the inner wall 34b corresponds to the outer casing 24 and borders the core flowpath P. Side wall portions 34c, 34d join the inner wall portion 34a to the outer wall portion 34b to form an oval-shaped cavity. That is, the inner and outer wall portions 34a, 34b are generally parallel to one another and to the engine axis A and are joined by curved wall portions 34c, 34d.

The shape of the cavity 32 is generally configured to be fabricated by additive manufacturing, which is discussed in more detail below. In general the cavity 32 has a long axis L which is parallel to the central axis A of the propulsion system 10. Said another way, the cavity is elongated in a direction parallel to the central engine axis A.

Other shapes, such as teardrop shapes, are also contemplated by this disclosure. The teardrop shaped cavity would still be oriented such that a long axis of the teardrop shape is parallel to the central axis A. FIG. 2B shows an example teardrop-shaped cavity 132 defined by wall 134.

The cavity 32 is configured to withstand high pressures, as discussed in more detail below. That is, the cavity 32 acts as a pressure vessel. The cavity 32 is free from intricate shapes, sharp corners, or other features that would facilitate the formation of super pressurized areas that can damage the integrity of the pressure vessel.

The cavity 32 is in fluid communication with the starter 26 via an injector 36. In some examples, as shown schematically in FIG. 3, the cavity 32 is also in fluid communication with a diffuser ring 38 adjacent the core engine 12 via a manifold 40. In this example, the injector assembly 30 provides and/or a pyrotechnic spark air to both the starter 26 and the combustor 16 via the diffuser ring 38 during start-up of the propulsion system.

The cavity 32 also includes a fitting 42. The fitting 42 can be any known fitting that enables the cavity 32 to be fluidly connected to a fluid source for charging the cavity 32. The cavity 32 is charged with air (e.g., ambient air), oxygen, or another oxygen-containing fluid via the fitting 42 prior to start-up of the propulsion system 10. In one example, the cavity 32 is charged to a pressure of between about 10-500 psi. Accordingly, the cavity 32 is designed to withstand pressures of between about 100-500 psi according to any known pressure vessel design features.

After start-up of the propulsion system 10, the cavity 32 is depleted from its initial charge. The cavity 32 serves as an air gap in the outer casing 24 which promotes cooling of the outer casing 24.

As discussed above, in this example, the injector assembly 30 is integral with the outer casing 24. Accordingly, the subsequent disclosure is related to manufacture of the outer casing 24 with injector assembly 30. However, it should be understood that where the injector assembly is integrated into a different component of the propulsion system 10, the subsequent disclosure still applies.

The outer casing 24 is manufactured by an additive manufacturing technique. Additive manufacturing involves building an article layer-by-layer from a powder material by consolidating selected portions of each successive layer of powder until the complete article is formed. For example, the powder is fed into a chamber, which may be under vacuum or inert cover gas. A machine deposits multiple layers of the powder onto one another. An energy beam, such as a laser, selectively heats and consolidates each layer with reference to a computer-aided design data to form solid structures that relate to a particular cross-section of the article. Other layers or portions of layers corresponding to negative features, such as cavities or openings, are not joined and thus remain as a powdered material. The unjoined powder material may later be removed using blown air, for example. With the layers built upon one another and joined to one another cross-section by cross-section, the article is produced. The article may be post-processed to provide desired structural characteristics. For example, the article may be heat treated to produce a desired microstructure. Additive manufacturing processes can include, but are not limited to, selective laser melting, direct metal laser sintering, electron beam melting, 3D printing, laser engineered net shaping, or laser powder forming. In this regard, the injector assembly 30 is seamless with regard to distinct boundaries that would otherwise be formed using techniques such as welding or brazing. Thus, the (monolithic) outer casing 24, in one example, is free of seams such that there are no distinct boundaries or discontinuities in the outer casing 24 that are visually or microscopically discernable.

FIG. 4 schematically shows an example additive manufacturing tool 400, such as a laser, which can print a component 402 by any of the additive manufacturing techniques described above or another additive manufacturing technique. In the example of FIG. 4, the additive manufacturing tool 400 is printing the outer casing 24 described above, however, the additive manufacturing tool 400 can print any of the structures described herein.

Additive manufacturing of the outer casing 24 proceeds in a build direction D as shown in FIG. 2A. In general, the build direction D is parallel to a long axis L of the cavity 32, which is most conducive to the additive manufacturing process and prevents caving-in of the cavity 32 during manufacture.

In some examples, a support structure 44 provides support for the cavity 32 during manufacture. That is, material is built up around the support structure with the tool 400 such that the cavity 32 is formed. In a particular example, the support structure 44 remains in the cavity 32 during operation of the propulsion system 10. Accordingly, the support structure does not interfere with the integrity of the cavity and its ability to withstand the required pressure as well as provide air to the starter 26 and/or combustor 16 as discussed above.

In some examples, the injector 36 has a diameter that enables removal of additive manufacturing residue/excess material after the additive manufacturing procedure.

Additive manufacturing of the outer casing 24 with integrated injector assembly 30 allows for unitizing of propulsion system 10 assemblies, integrates complex performance-enhancing features of the propulsion system 10 with one another, lowers production costs, and reduces manufacturing and assembly time/complexity. For example, integration of the cavity 32 eliminates the need for a separate pressure bottle and all of the associated fittings for the pressure bottle. These benefits are particularly important to attritable/expendable systems because of the low cost-target and assembly effort requirements.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A propulsion system, comprising:
a core engine; and
an outer casing surrounding the core engine, the outer casing including an integral injector assembly, the injector assembly including a wall that defines a cavity, the wall being integral with the outer casing.

2. The propulsion system of claim 1, wherein the wall includes an inner wall portion and an outer wall portion with respect to a central engine axis, and wherein the inner wall portion corresponds to the engine casing.

3. The propulsion system of claim 2, wherein the wall further includes first and second curved side wall portions that join the inner wall portion and outer wall portion to one another.

4. The propulsion system of claim 1, wherein the cavity is elongated in a direction that is parallel to a central engine axis.

5. The propulsion system of claim 1, wherein the cavity is teardrop-shaped.

6. The propulsion system of claim 1, wherein at least a portion of the wall of the cavity borders a core flowpath of the core engine.

7. The propulsion system of claim 1, wherein the injector is in fluid communication with a starter.

8. The propulsion system of claim 1, wherein the injector is in fluid communication with the core engine.

9. The propulsion system of claim 1, wherein the injector is in fluid communication with a diffuser ring adjacent a combustor in the core engine.

10. The propulsion system of claim 9, wherein the injector is in fluid communication with the diffuser ring via a manifold.

11. A method of operating a propulsion system, comprising:
starting a propulsion system by providing pressurized gas from a cavity to a starter, the starter configured to create a pyrotechnic spark which enables start-up rotation of a core engine, wherein the cavity is defined by a wall, the wall being integral with an outer casing of the propulsion system.

12. The method of claim 11, further comprising providing the pressurized gas from the cavity to the core engine.

13. The method of claim 11, further comprising charging the cavity with the pressurized gas prior to the starting step.

14. The method of claim 13, wherein the cavity is charged to a pressure of between about 10 and 500 psi.

15. The method of claim 11, wherein the cavity is depleted of pressurized gas by the starting step, and wherein the cavity subsequently serves as an air gap.

16. A method of making a component of a propulsion system, comprising:
depositing material using an additive manufacturing technique to form a component with an injector assembly, the injector assembly including a cavity defined by a wall, the wall being integral with the component, and an injector in fluid communication with the cavity.

17. The method of claim 16, wherein the component is an outer casing of a propulsion system.

18. The method of claim 16, wherein the cavity has a long axis, and the long axis is generally parallel to a build direction in which the material is deposited.

19. The method of claim 18, wherein the cavity is oval-shaped.

20. The method of claim 18, wherein the cavity is teardrop shaped.
